(19) United States
(12) Patent Application Publication
(10) Pub. No.: US 2024/0110315 A1
(43) Pub. Date: Apr. 4, 2024

(54) COMPOSITION AND METHOD FOR MAKING ULTRA-FINE, HIGH TENACITY AND HIGH TOUGHNESS POLYMERIC MULTIFILAMENTS

(71) Applicant: Nano and Advanced Materials Institute Limited, Hong Kong (CN)

(72) Inventors: Kang ZHANG, Hong Kong (CN); Christopher Cheung YEC, Hong Kong (CN); Shilong ZHANG, Hong Kong (CN); Jifan LI, Hong Kong (CN)

(21) Appl. No.: 18/457,479

(22) Filed: Aug. 29, 2023

Related U.S. Application Data
(60) Provisional application No. 63/377,755, filed on Sep. 30, 2022.

(51) Int. Cl. D01F 8/14; D01D 5/30

(52) U.S. Cl. CPC D01F 8/14; D01D 5/30; D10B 2321/021; D10B 2321/022; D10B 2331/02; D10B 2331/04; D10B 2401/063

(57) ABSTRACT

The present invention provides a composition and method for forming polymeric multifilaments having a filament diameter of no more than 10 μm with a high tensile strength and toughness. The composition includes at least one semi-crystalline thermoplastic polymer and a nucleating agent to stabilize the multifilaments during melt-spinning and facilitate phase transformation of the thermoplastic polymer in subsequent drawing and annealing cycles. The method includes a quenching step for the melt-spun filaments immediately after the melt-spinning and collection of the quenched filaments with a specific winding speed to decrease the filament diameter. The subsequent drawing and annealing cycles further enhance the mechanical properties of the filaments after the quenching.

### CROSS-REFERENCE TO RELATED APPLICATION

This application claims priority from the U.S. provisional patent application Ser. No. 63/377,755 filed Sep. 30, 2022, the disclosure of which is incorporated herein by reference.

### TECHNICAL FIELD

The present invention generally relates to a composition and method for making ultra-fine, high tenacity and high toughness polymeric multifilaments, in particular, for making ultra-fine, high tenacity and high toughness multifilaments from melt-extrudable/spinnable thermoplastic polymers.

### BACKGROUND

There are various ways to make multifilament from thermoplastic polymer such as polypropylene (PP) since it has a wide variety of applications due to its thermal stability, lightweight, high strength, low cost, and recyclability. Major schemes of making multifilament from polypropylene or alike include melt-extrusion, electrospinning, and melt blowing. For instance, U.S. Pat. No. 9,057,148B2 teaches PP monofilament made by melt extrusion, in which the filament was rapidly quenched to a temperature within ±15° C. of its glass transition temperature after melt extrusion and stored within ±15° C. of its glass transition temperature for several days, followed by drawing of the monofilament to improve its tenacity. The resulting monofilament has a tensile strength of 1.6 GPa or more, but the method requires hand drawing at a slow speed and storage for several days at 0° C. The method also only results in a PP monofilament instead of multifilament, which was not designed for making PP multifilament at an industrial scale. The monofilament resulted from that method was not smaller than 11 μm.

The other patent, U.S. Pat. No. 9,677,199B2, teaches inclusion of sorbitol-based nucleating agent in the composition for forming polypropylene, and subsequent drawing to produce multifilament with modulus as high as 8 GPa and tenacity as high as 11.6 g/d (˜921 MPa). However, the elongation of the highest tenacity is below 9.3% and the diameter per filament is 51 denier (˜90 μm).

Similarly, U.S. Pat. No. 6,759,124B2 is another patent teaching using sorbitol-based nucleating agent to improve shrinkage resistance of polypropylene fiber when exposed in temperatures around 150° C.

US20180202077A1 discloses a two-stage drawing step performed at two different temperatures to obtain polypropylene fiber with fineness between 3 and 20 dtex (˜20.5-53 μm), and strengths not lower than 7 cN/dtex (˜628 MPa). Although the modulus of the resulting filaments was still below 1 GPa, and their diameter was above 20 μm, the amorphous orientation and crystalline orientation of the fiber were high.

However, none of the prior arts known to the inventors so far discloses a method of making multifilaments from semi-crystalline melt-extrudable/spinnable thermoplastic polymers such as high molecular weight polypropylene to reach a significantly small diameter of no more than 10 μm with a high tenacity such as high tensile strength and toughness which is ready to be scaled up to industrial level. A need therefore exists for an improved method and composition that eliminates or at least diminishes the disadvantages and problems described above.

### SUMMARY OF INVENTION

Accordingly, an aspect of the present invention provides a composition comprising at least one polymer which is not amorphous but preferably semi-crystalline for forming multifilaments each having an average diameter of 10 μm or lower under a series of conditions during melt-extrusion/spinning and when being subjected to multiple drawing and annealing cycles before final multifilaments are formed.

In certain embodiments, at least one semi-crystalline thermoplastic polymer in the composition comprises one or more of polypropylenes (PP), polyethylene (PE), polyethylene terephthalate (PET), and polyamide 6 (PA 6).

Preferably, the polypropylenes (PP) have a high molecular weight and/or melt flow index (MR).

In certain embodiments, the polypropylenes comprise isotactic polypropylene with a molecular weight of about 341 kDa and/or a polypropylene with an MFI of 1500.

In certain embodiments, the isotactic polypropylene has a melt index of 4 g/10 minutes at about 230° C. under 2.16 kg load.

In certain embodiments, the isotactic polypropylene with a molecular weight of about 341 kDa and the polypropylene with the MFI of 1500 are in a weight ratio of 10 to 7:0 to 3 in the composition.

In exemplary embodiments, the composition further comprises a nucleating agent and one or more antioxidants.

In certain embodiments, the nucleating agent is a sorbitol-based nucleating agent.

In exemplary embodiments, the sorbitol-based nucleating agent is selected from 1,3:2,4-bis(3,4-dimethylbenzylidene)sorbitol (DMDBS).

Optionally, the sorbitol-based nucleating agent can be selected from 1,3:2,4-Dibenzylidene-D-sorbitol (DBS).

In certain embodiments, the one or more antioxidants is a blend of two different anti-oxidants.

In certain embodiments, the two different anti-oxidants in the blend are selected from a phenolic antioxidant and a hydrolytically stable phosphite processing stabilizer in a weight ratio of 1:2.

Preferably, the phenolic antioxidant is selected from pentaerythritol tetrakis(3,5-di-tert-butyl-4-hydroxyhydrocinnamate) (IRGANOX® 1010); the hydrolytically stable phosphite processing stabilizer is selected from tris(2,4-di-tert-butylphenyl) phosphite (IRGAFOS® 168).

In certain embodiments, the at least one semi-crystalline thermoplastic polymer, the nucleating agent, and the one or more anti-oxidants in the composition are in a weight ratio of 993:4:3.

In certain embodiments, each of the filaments has an average diameter of about 4 to 10 μm, a tensile strength of greater than 1 GPa, a toughness of greater than 100 MJ/m³, and an elongation at break of at least 15%.

Another aspect of the present invention provides a method for forming multifilaments from the composition described in the first aspect or according to any embodiments described herein.

The method for forming the multifilaments from said composition includes:
melt-spinning said composition under an inert gas environment on a multiple orifice die to generate a plurality of filaments;
quenching the plurality of the filaments at a first temperature within a range higher or lower than a glass transition temperature of the at least one polymer in the composition to obtain a plurality of quenched filaments;
collecting the quenched filaments with a winder at a winding speed to obtain a plurality of as-spun filaments;
drawing the plurality of as-spun filaments on a multiple furnace platform at a second temperature and with a second winding ratio;
repeating said drawing for at least five times to obtain a plurality of drawn filaments; annealing the plurality of drawn filaments at a third temperature on a multiple furnace platform as in said drawing and with a third winding ratio;
repeating said annealing for at least twice to obtain a plurality of annealed filaments.

In certain embodiments, the inert gas environment is provided by supplying an inert gas comprising nitrogen, and argon at a pressure from 1,000 to 2,000 kPa.

In certain embodiments, the multiple orifice die for said melt-spinning has an orifice number between 10 and 20.

In certain embodiments, each of the orifices of the multiple orifice die for said melt-spinning has an average size of about 0.15 mm.

In certain embodiments, the first temperature for said quenching is about 15 to 25° C. higher or lower than the glass transition temperature of the at least one polymer in the composition.

In exemplary embodiments, the at least one polymer in the composition is one or more polypropylenes.

Preferably, the one or more polypropylenes are isotactic polypropylene with the other polypropylene having an MFI of 1500 such that the first temperature is about 0° C. to 8° C. for said quenching.

In certain embodiments which said melt-spinning the composition comprising one or more polypropylenes, a melt extrusion temperature of about 205 to 250° C. is used.

The melt extrusion temperature and quenching temperature vary depending on the polymer to be used in said composition for said melt-spinning.

In certain embodiments, the first winding speed of the winder used for said collecting the quenched filaments is up to 200 m/min.

Preferably, the winding speed of the winder for said collecting the quenched filaments is not lower than 100 m/min.

In certain embodiments, the second temperature for said drawing is lower than the third temperature for said annealing.

In certain embodiments, the second temperature for said drawing is about 140° C. to 155° C.

In certain embodiments, the second winding ratio for said drawing is higher than the third winding ratio for said annealing.

In certain embodiments, the second winding ratio for said drawing is up to 6.

In certain embodiments, the multiple furnace platform comprises at least three furnaces each has an equal length and spacing to the other furnace.

Preferably, each of the at least three furnaces has a length of about 40.5 cm; the spacing is about 6.5 cm between two of the furnaces.

In certain embodiments, said drawing is repeated for at least five times before said annealing.

In certain embodiments, the third temperature for said annealing is about 160° C. to 170° C.

In certain embodiments, the third winding ratio is up to 1.2.

In certain embodiments, said annealing is repeated for at least twice before obtaining said plurality of annealed filaments.

In exemplary embodiments, said annealing is performed on the same multiple furnace platform as that for said drawing.

In certain embodiments, said plurality of annealed filaments are the multifilaments with an average diameter of 4 to 10 μm, tensile toughness of at least 100 MJ/m³, tensile strength of greater than 1 GPa, an elongation at break of at least J and a filament count of at least 10 per batch.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects of the present invention are disclosed as illustrated by the embodiments hereinafter.

### BRIEF DESCRIPTION OF DRAWINGS

The appended drawings, where like reference numerals refer to identical or functionally similar elements, contain figures of certain embodiments to further illustrate and clarify the above and other aspects, advantages, and features of the present invention. It will be appreciated that these drawings depict embodiments of the invention and are not intended to limit its scope. The invention will be described and explained with additional specificity and detail through the use of the accompanying drawings in which:

FIG. 1 schematically depicts a setup for performing melt-spinning and quenching procedures to obtain as-spun filaments from the present composition according to certain embodiments;

FIG. 2 schematically depicts a setup for performing drawing cycles of the as-spun filaments obtained from the procedures depicted in FIG. 1 to result in drawn filaments according to certain embodiments;

FIG. 3 schematically depicts a setup for performing annealing cycles of the drawn filaments obtained from the procedures depicted in FIG. 2 to result in annealed filaments according to certain embodiments of the present invention;

FIG. 4 shows images of filaments obtained at different stages (left panel: as-spun filaments; right panel: annealed filaments) by the present method according to certain embodiments of the present invention;

FIG. 5 shows the difference in tensile toughness in terms of an area under a tensile stress-strain curve among different as-spun filaments having different diameters resulting from different embodiments of the present invention;

FIG. 6 shows the tensile toughness of annealed filaments prepared according to certain embodiments of the present invention;

FIG. 7 shows a flowchart of the present method according to certain embodiments.

Skilled artisans will appreciate that elements in the figures are illustrated for simplicity and clarity and have not necessarily been depicted to scale.

### DETAILED DESCRIPTION OF THE INVENTION

It will be apparent to those skilled in the art that modifications, including additions and/or substitutions, may be made without departing from the scope and spirit of the invention. Specific details may be omitted so as not to obscure the invention; however, the disclosure is written to enable one skilled in the art to practice the teachings herein without undue experimentation.

The present disclosure provides composition and method for forming multifilaments from semi-crystalline, non-amorphous thermoplastic polymers, for example, one or more types of polypropylene with at least one high molecular weight polypropylene and optionally another polypropylene with a relatively low melt flow index (MFI) such as a PP with an MFI of 1500. The resulting multifilaments have an average target diameter of 4 to 10 μm, tensile strength of greater than 1 GPa, a toughness of greater than 100 MJ/m³ and an elongation at break of at least 15%. The present method should also be applicable to other potential thermoplastic polymers such as PE, PET, and PA6, or any semi-crystalline thermoplastic polymers which are not amorphous before processing. The present method also adopts several drawing and annealing cycles after quenching the melt-spun filaments to enable high tensile strength and toughness of the final multifilaments while the target filament count (˜10 to 20 filaments) and diameter (˜4 to 10 μm) are realized.

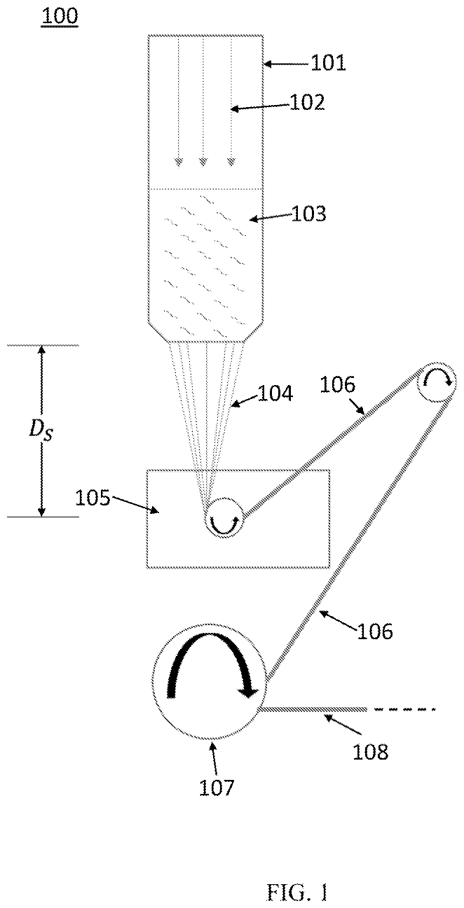

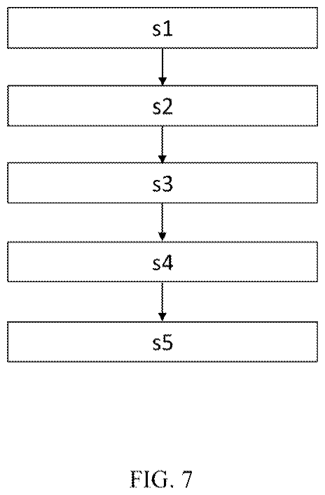

FIG. 1 depicts a setup 100 of performing melt-spinning (corresponding to s2 in FIG. 7) of the present composition 103 for forming filaments 104 from a melt extrusion chamber 101 under an inert gas supply 102 with an elevated pressure of about 1000 kPa to 2000 kPa, followed by quenching and subject to a first winding at a winding speed. In exemplary embodiment, the composition comprising isotactic polypropylene (PP) with a molecular weight of about 341 kDa, a sorbitol-based nucleating agent, and optionally a small portion of another PP (MFI=1500), is melted at about 205 to 250° C. and then extruded on a multiple orifice die (not shown in the schematic of FIG. 1). To control or vary the size of the filament, the die orifice count and/or size of each orifice can vary. In this case, an orifice count of about 10 to 20 holes each having a diameter of about 0.15 mm is used to intend to generate 10 to 20 filaments. The orifice count and its size will also affect the melt extrusion pressure. The smaller the orifice size is or the higher the orifice count is, the larger is the melt extrusion pressure used in general. Apart from the orifice count and size, the spinning path length, i.e., the distance between the orifice and the winder, or the distance (D_{S}) between the melt extruder 101 and a spin-wheel of an ice-water bath 104 in FIG. 1, will also affect the parameters used and stability of the melt extrusion, and quenching duration in the subsequent step. In certain embodiments, the spinning path length is about 65 cm. The quenching duration is relatively short, which is usually up to 1 second.

After melt-spinning the composition 103 to obtain a plurality of filaments 104, the filaments 104 are rapidly cooled (or quenched) (corresponding to s3 in FIG. 7) in a water bath 105. Depending on the thermoplastic polymer(s) used to prepare the composition, the quenching temperature is within 15 to 25° C. higher or lower than the glass transition (Ts) temperature of the thermoplastic polymer(s) used. Preferably, the quenching temperature is ±15° C. of the glass transition temperature of the thermoplastic polymer(s) used. In the case where the composition comprises nearly 80% or more by weight of isotactic PP, the quenching temperature of the water bath 105 is about 0° C. to 8° C.

After quenching in the water bath 105, the quenched filaments 106 are collected by a winder 107 at the winding speed of about 180 m/min or lower (can be up to 200 m/min) to obtain as-spun filaments. The as-spun filaments 108 will subsequently be drawn on a multiple furnace platform for several times at a drawing temperature with a winding ratio of up to 6.

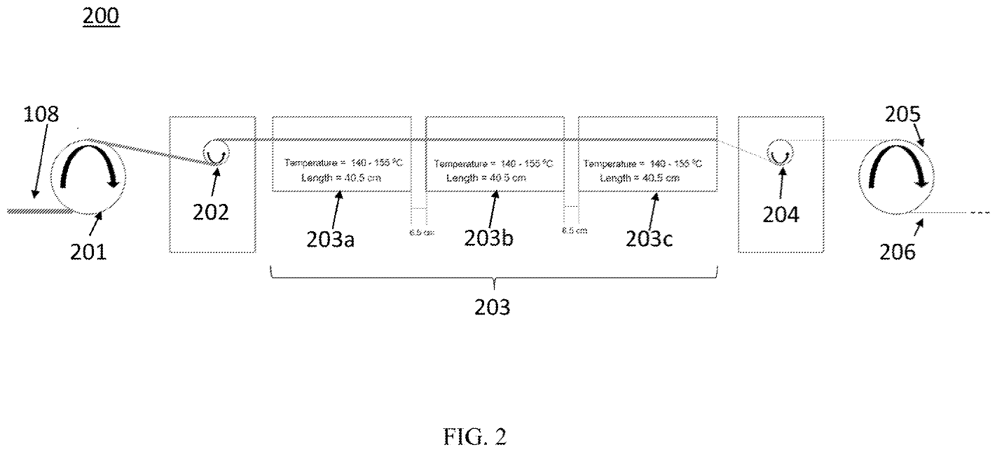

Turning to FIG. 2, a setup 200 for performing each cycle of drawing the as-spun filaments 108 (corresponding to s4 in FIG. 7) on a multiple furnace platform is depicted, in which the multiple furnace platform 203 is composed of three furnaces (203a, 203b, 203c) each having a length of about 40.5 cm and spaced apart from each other with a distance of about 6.5 cm. Each drawing furnace is set to a temperature ranging from 140 to 155° C. Initially, each of as-spun filaments 108 is fed to a filament unwinder 201 at a first (unwinding) speed (v₁). Subsequently, the unwound filament will be fed to a first drawing godet 202 at a second speed (v₂) before being drawn on a first furnace 203a. After being drawn sequentially on the first, second and third furnaces (203a, 203b, 203c), the filament will be fed to a second drawing godet 204 at a third speed (v₃), where v₂≤v₃≤6v₂. The filament will be wound by a filament winder 205 at a fourth (winding) speed (v₄), where v₁≤v₄≤6v₁. Overall, the winding ratio during the drawing process is up to 6. After repeating the drawing cycle for at least five times, the drawn filament 206 will be fed to the next stage, annealing.

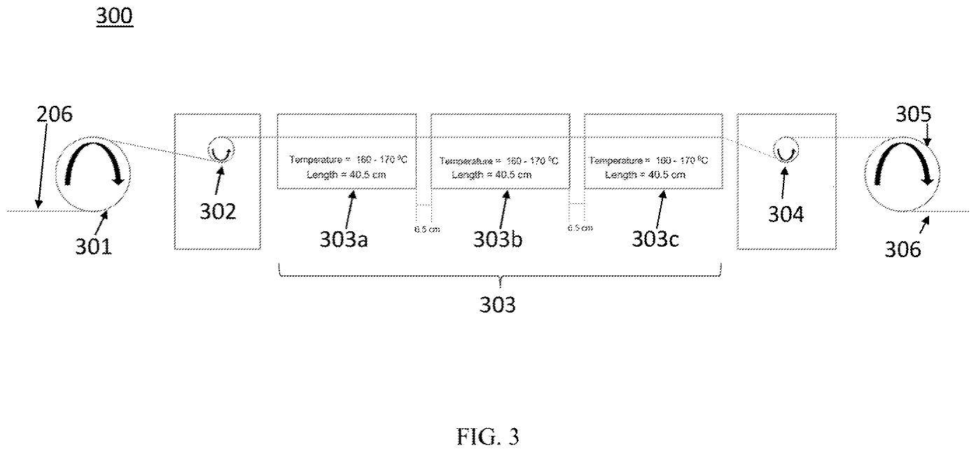

Turning to FIG. 3, a setup 300 for performing each cycle of annealing the drawn filaments 206 (corresponding to s5 in FIG. 7) is depicted. Similar to the drawing of the as-spun filaments as depicted in FIG. 2, the annealing of the drawn filaments is also preferably performed on a multiple furnace platform 303. In exemplary embodiments, the multiple furnace platform 303 for performing the annealing of the drawn filaments is the same as that for the drawing of the as-spun filaments, which is composed of three furnaces (303a, 303b, 303c). That being said, the same multiple furnace platform used in the drawing step is used for the annealing step. The main difference between the one for the drawing step and that for the annealing step is the temperature, where the temperature for the annealing step is higher than that for the drawing step. In certain embodiments, the annealing temperature is about 5 to 30° C. higher than the drawing temperature, and cannot be lower than 160° C. Preferably, the annealing temperature used at each furnace is from about 160 to 170° C.

Initially, each of the drawn filaments 206 is fed to a filament unwinder 301 at a fifth (unwinding) speed (v₅). Subsequently, the unwound filament will be fed to a drawing godet 302 at a sixth speed (v₆) before being annealed on a first furnace 303a. After being annealed sequentially on the first, second and third furnaces (303a, 303b, 303c), the filament will be fed to a second drawing godet 304 at a seventh speed (v₇), where v₆≤v₇≤1.2v₆. The filament will be wound by a filament winder 305 at an eighth (winding) speed (v₈), where v₅≤v₈≤1.2v₅. Overall, the winding ratio during the annealing process is up to 1.2. After repeating the annealing cycle for at least twice, the annealed filament 306 will be obtained.

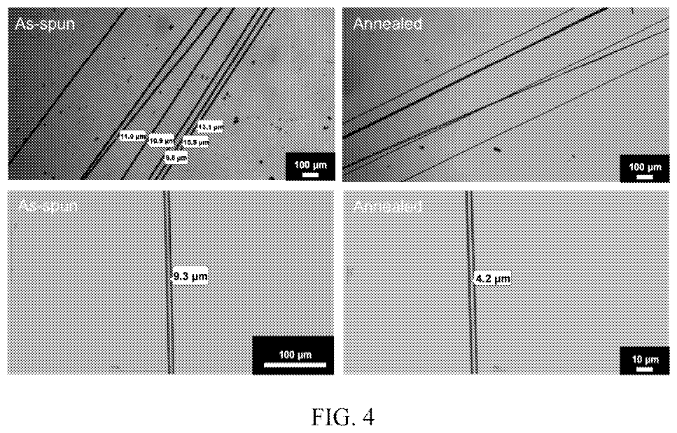

FIG. 4 shows the appearance of the filaments before and after drawing and annealing steps according to certain embodiments. On the left panel of FIG. 4, the as-spun filaments after the quenching step have an average diameter from about 8 to 11 μm; whereas the annealed filaments as shown on the right panel of FIG. 4 have an average diameter from about 3 to 4 μm. As described hereinabove, the diameter of the as-spun filaments may vary by changing the size/count of multiple die orifice used during the melt-spinning, and/or the melt-spinning and/or quenching conditions such as the pressure used to supply the inert gas, the spinning path length, quenching temperature, duration, etc. The diameter of the annealed filaments may vary by changing the number of drawing and/or annealing cycles, winding ratio at each of the cycles, and other conditions such as drawing and/or annealing temperature.

The following section provides examples for illustration purpose, which should not be considered as limiting the scope of the invention.

### Examples

Table 1 below summarizes mechanical and physical properties of different multifilaments prepared under different procedures and conditions.

TABLE 1

| | | Tensile | Elongation | | Winding | |
|---|---|---|---|---|---|---|
| | Diameter | Strength | at Break | Toughness | speed | |
| Example | (μm) | (MPa) | (%) | (MJ/m³) | (m/min) | Remarks* |
| 1 | 19.4 ± | 210 ± | 543 ± | 646 ± | 42 | As-spun, non- |
| | 0.6 | 13 | 48 | 86 | | quenched |
| 2 | 10.1 ± | 297 ± | 174 ± | 389 ± | 144 | As-spun, |
| | 1.3 | 68 | 34 | 103 | | quenched |
| 3 | 7.8 ± | 940 ± | 18.6 ± | 118 ± | — | Drawn filament |
| | 0.6 | 119 | 3.7 | 37 | | of Example 1 |
| 4 | 3.9 ± | 1752 ± | 18.1 ± | 186 ± | — | Drawn and |
| | 0.4 | 354 | 4 | 67 | | annealed |
| | | | | | | filament of |
| | | | | | | Example 2 |
| 5 | 19.3 ± | 172 ± | 560 ± | 680 ± | 94 | As-spun, non- |
| | 0.6 | 7 | 56 | 92 | | quenched, |
| | | | | | | blended with PP |
| | | | | | | (MFI: 1500) |
| 6 | 11.3 ± | 163 ± | 274 ± | 326 ± | 211 | As-spun, |
| | 0.6 | 18 | 49 | 85 | | quenched, |
| | | | | | | blended with PP |
| | | | | | | (MFI: 1500) |
| 7 | 5.2 ± | 1072 ± | 15.1 ± | 108 ± | — | Drawn filament |
| | 0.3 | 257 | 4 | 51 | | of Example 5 |
| 8 | 5.5 ± | 1357 ± | 20.4 ± | 180 ± | — | Drawn and |
| | 0.3 | 140 | 4.9 | 61 | | Annealed |
| | | | | | | filament of |
| | | | | | | Example 5 |
| 9 | 4.95 ± | 1122 ± | 18.4 ± | 114 ± | — | Drawn filament |
| | 0.3 | 180 | 3.4 | 36 | | of Example 6 |
| 10 | 4.4 ± | 1459 ± | 18.8 ± | 161 ± | — | Drawn and |
| | 0.3 | 300 | 3.8 | 63 | | Annealed |
| | | | | | | filament of |
| | | | | | | Example 6 |
| 11 | 5.9 ± | 1018 ± | 17.0 ± | 105 ± | — | Drawn filament |
| | 0.3 | 223 | 4.2 | 37 | | of Example 6 |
| | | | | | | using single |
| | | | | | | furnace |

*All drawn filaments are subject to 5 cycles of drawing

From the results in Table 1, it is suggested that quenching of melt-spun multifilaments allows higher winding speed during melt-spinning (42 m/min in Example 1 vs. 144 m/min in Example 2; 94 m/min in Example 5 vs. 211 m/min in Example 6), resulting in a smaller diameter of the as-spun filaments (19.4±0.6 in Example 1 vs. 10.1±1.3 in Example 2; 19.3±0.6 in Example 5 vs. 11.3±0.6 in Example 6). It is also suggested that drawing and/or annealing of the as-spun filaments from Examples 1 and 2 (drawn only filaments in Examples 3 and 4 obtained from Examples 1 and 2, respectively) or from Examples 5 and 6 (Examples 7 and 9 are drawn only filaments from Examples 5 and 6, respectively; Examples 8 and 10 are drawn and annealed filaments from Examples 5 and 6, respectively) increase the tensile strength of the multifilaments while decreasing the diameter thereof (Example 1 vs. Example 3; Example 2 vs. Example 4; Example 7 vs. Example 8; Example 9 vs. Example 10). It is further suggested that a multiple furnace platform for drawing the as-spun filament is better than single furnace in terms of the diameter of the filament (Example 9 vs. Example 11).

Table 2 below summarizes the weight percentage of different components used in the composition for forming the multifilaments of Examples 1-11 as outlined in Table 1.

TABLE 2

| Examples | IPP 341 kDa\hat{ } | DMDBS | 1010* | 168* | PP w/MFI 1500 |
|---|---|---|---|---|---|
| 1-4 | 99.3% | 0.4% | 0.1% | 0.2% | — |
| 5-11 | 79.44% | 0.4% | 0.1% | 0.2% | 19.86% |

\hat{ }Isotactic polypropylene with molecular weight of ~341 kDa
*1010: IRGANOX ® 1010; 168: IRGAFOS ® 168

From the results in the above examples, it is believed that quenching the multifilaments before any subsequent processing can inhibit crystallization and maximize the portion of amorphous phase of polypropylene, thereby stabilizing polypropylene multifilaments during melt-spinning. It is suggested that winding the quenched filaments at a winding speed of higher than 100 m/min can at least partially orient the amorphous phase of the polypropylene, thereby controlling the diameter of the corresponding as-spun filaments to less than 15 μm per filament. Subjecting the as-spun filaments after quenching to several drawing cycles at a temperature from 140 to 155° C. facilitates further orientation of amorphous phase of the polypropylene to form α1 crystal phase. Subsequent annealing cycles applied to the drawn filaments at a temperature from 160 to 170° C. enables phase transformation from α1 to α2 crystalline phase of the polypropylene. Crystalline transformation of amorphous polypropylene into both α1 and α2 phases enhance the tensile strength of the filaments. It is observed that the higher the overall winding ratio is used (e.g., up to 6) at the drawing cycles, the higher is the tensile strength of the final multifilaments. Subsequently, a winding ratio of up to 1.2 used at the annealing cycles is observed to further enhance the tensile strength (and toughness) of the final multifilaments, compared to those drawn and annealed under a lower winding ratio, respectively. Tables 3-5 below summarize the conditions/parameters of melt-spinning, drawing and annealing stages, respectively, used in the corresponding examples of the present disclosure.

TABLE 3
Melt-spinning Parameters:

| Parameters | Value |
|---|---|
| Melt Temperature (° C.) | 210 |
| Inert Gas Pressure (kPa) | 1600 |
| Orifice dimension (mm) | 0.15 |
| Orifice count | 15 |
| Winding Speed (m/min) | 144 |

TABLE 4
Drawing Parameters:

| Parameters | Value |
|---|---|
| Furnace Temperature (° C.) | 150 |
| Winding Ratio (1^{st} Stage) | 3.5x |
| Winding Ratio (2^{nd} Stage) | 1.15x |
| Winding Ratio (3^{rd} Stage) | 1.15x |
| Winding Ratio (4^{th} Stage) | 1.09x |
| Winding Ratio (5^{th} Stage) | 1.09x |
| Overall Winding Ratio | 5.5x |

TABLE 5
Annealing Parameters:

| Parameters | Value |
|---|---|
| Furnace Temperature (° C.) | 165 |
| Winding Ratio (1^{st} Stage) | 1.07x |
| Winding Ratio (2^{nd} Stage) | 1.07x |
| Overall Winding Ratio | 1.14x |

In addition, inclusion of sorbitol-based nucleating agent, such as DMDBS, in the composition for melt-spinning and subsequent processing described herein increases crystallization efficiency during the phase transformation of the polypropylene. Table 6 below shows the difference in various mechanical properties between the PP multifilaments formed from the compositions with and without the DMDBS (the concentration of the remaining components in the compositions are identical to that for forming Examples 1-4 in Table 2). Additional antioxidants in the composition for melt-spinning also ensure thermal stability and uniformity during melt-spinning and subsequent processing at high temperature for the filaments before the final multifilaments are obtained.

TABLE 6

| | Average | Average | Average | |
|---|---|---|---|---|
| | Fiber | Tensile | Elongation | Average |
| | Diameter | Strength | at Break | Toughness |
| | (μm) | (MPa) | (%) | (MJ/mm³) |
| Without | 19.1 ± 0.85 | 960 ± 34 | 27 ± 3 | 189 ± 27 |
| DMDBS | | | | |
| With 0.4% | 7.8 ± 0.6 | 940 ± 119 | 18.6 ± 3.7 | 118 ± 37 |
| DMDBS | | | | |

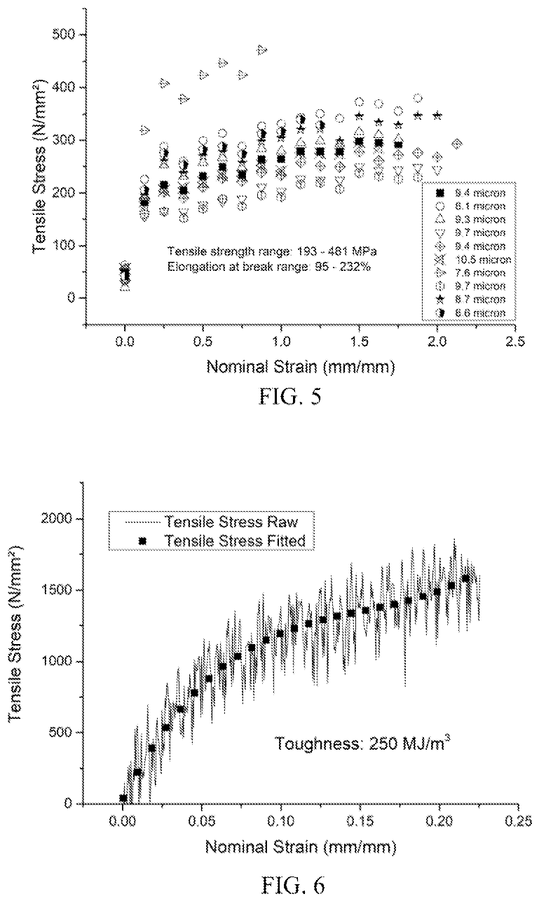

FIG. 5 shows a comparison of the tensile toughness (determined by the area of the corresponding stress-strain curve) among different as-spun filaments with different filament diameters from 8.1 μm up to 10.5 μm. Within this range of as-spun filament diameters, a tensile strength from 193 to 481 MPa, an elongation at break of 95% to 232% per filament, and an average tensile toughness of 389 MJ/m³ are obtained.

FIG. 6 shows the tensile strength of a single filament from multifilaments formed from the same composition as that for forming Examples 1-4 in Table 2 and after annealing. The tensile strength and tensile toughness of this single filament from the annealed multifilaments are greater than 1 GPa (can be up to 1.7 GPa) and 187 MJ/m³, respectively.

FIG. 7 summarizes the key stages of the present method according to certain embodiments, where the method begins with providing a melt-spinnable/extrudable composition comprising at least one semi-crystalline thermoplastic polymer such as isotactic polypropylene with M.W. of about 341 kDa, a sorbitol-based nucleating agent and a blend of antioxidants (s1), followed by loading the same into a melt extruder under a pressurized inert gas and through a multiple orifice die to carry out melt-spinning to obtain a plurality of melt-spun filaments (s2). The melt-spun filaments are then immediately subject to rapid cooling or quenching at a temperature slightly lower than the glass transition temperature of the thermoplastic polymer used in the composition in a water bath disposed at a spinning path length away from the melt extruder and subsequently collected by a winder at a high winding speed of higher than 100 m/min and up to 200 m/min to obtain as-spun filaments (s3). The as-spun filaments are then subject to drawing at a drawing temperature on a multiple furnace platform with a winding ratio of up to 6 and being drawn by 5 cycles or more (s4). The drawn filaments are further annealed on the same multiple furnace platform with a winding ratio of up to 1.2 and at an annealing temperature slightly higher than the drawing temperature and sufficient to transform most of the amorphous polypropylenes into α₁ and α₂ crystalline phases for at least two cycles (s5). The annealed filaments, which are the final multifilaments, are desired to have an average diameter of 4 to 10 μm, a tensile strength of greater than 1 GPa (e.g., within a range from 1.0 to 1.7 GPa), a tensile toughness of at least 100 MJ/m³, and about 10-20 filaments per batch of isotactic polypropylene having a melt index of 4 g/10 min at 230° C. under 2.16 kg load.

Although the invention has been described in terms of certain embodiments, other embodiments apparent to those of ordinary skill in the art are also within the scope of this invention. Accordingly, the scope of the invention may be intended to be defined only by the claims which follow, if any.

What is claimed is:

1. A melt-spinnable or melt-extrudable polymeric composition for forming polymeric multifilaments with a small average filament diameter, high tensile strength and tensile toughness, the composition comprising:
at least one semi-crystalline thermoplastic polymer;
a nucleating agent; and
one or more anti-oxidants.

2. The polymeric composition of claim 1, wherein the at least one semi-crystalline thermoplastic polymer comprises polypropylene, polyethylene, polyethylene terephthalate, and polyamide 6.

3. The polymeric composition of claim 2, wherein the polypropylene is one or both of isotactic polypropylene having a molecular weight of about 341 kDa and a polypropylene having a melt flow index (MFI) of 1500.

4. The polymeric composition of claim 3, wherein the isotactic polypropylene has a melt index of 4 g/10 minutes at about 230° C. under 2.16 kg load.

5. The polymeric composition of claim 3, wherein the isotactic polypropylene and the polypropylene with the MFI of 1500 are in a weight ratio of 10:0 to 7:3.

6. The polymeric composition of claim 1, wherein the nucleating agent is a sorbitol-based nucleating agent.

7. The polymeric composition of claim 6, wherein the sorbitol-based nucleating agent is selected from 1,3:2,4-bis(3,4-dimethylbenzylidene)sorbitol or 1,3:2,4-dibenzylidene-D-sorbitol.

8. The polymeric composition of claim 1, wherein the one or more antioxidants is a blend of two different anti-oxidants.

9. The polymeric composition of claim 8, wherein the two different anti-oxidants are selected from a phenolic antioxidant and a hydrolytically stable phosphite processing stabilizer in a weight ratio of 1:2.

10. The polymeric composition of claim 9, wherein the phenolic antioxidant is selected from pentaerythritol tetrakis(3,5-di-tert-butyl-4-hydroxyhydrocinnamate); the hydrolytically stable phosphite processing stabilizer is selected from tris(2,4-di-tert-butylphenyl) phosphite.

11. The polymeric composition of claim 1, wherein the at least one semi-crystalline thermoplastic polymer, the nucleating agent, and the one or more anti-oxidants in the composition are in a weight ratio of 993:4:3.

12. A polymeric multifilament formed from the polymeric composition of claim 1, having an average filament diameter of 4 to 10 μm, tensile strength of greater than 1 GPa, tensile toughness of greater than 100 MJ/m³, and an elongation at break of at least 15%.

13. A method for forming a polymeric multifilament comprising:
providing the composition of claim 11;
melt-spinning said composition under an inert gas environment on a multiple orifice die to generate a plurality of filaments;
quenching the plurality of the filaments at a first temperature within a range higher or lower than a glass transition temperature of the at least one semi-crystalline thermoplastic polymer in the composition to obtain a plurality of quenched filaments;
collecting the quenched filaments with a winder at a winding speed to obtain a plurality of as-spun filaments;
drawing the plurality of as-spun filaments on a multiple furnace platform at a second temperature and with a second winding ratio;
repeating said drawing for at least five times to obtain a plurality of drawn filaments;
annealing the plurality of drawn filaments at a third temperature on a multiple furnace platform as in said drawing and with a third winding ratio; and
repeating said annealing for at least twice to obtain a plurality of annealed filaments.

14. The method of claim 13, wherein the inert gas environment is provided by supplying an inert gas comprising nitrogen and argon at a pressure from 1,000 to 2,000 kPa.

15. The method of claim 13, wherein the multiple orifice die for said melt-spinning has an orifice number between 10 and 20.

16. The method of claim 15, wherein each of the orifices of the multiple orifice die for said melt-spinning has an average size of about 0.15 mm.

17. The method of claim 13, wherein the first temperature for said quenching is about 15 to 25° C. higher or lower than the glass transition temperature of the at least one semi-crystalline thermoplastic polymer in the composition.

18. The method of claim 17, wherein the at least one semi-crystalline thermoplastic polymer is one or both of isotactic polypropylene with the other polypropylene having an MFI of 1500 such that the first temperature is about 0° C. to 8° C. for said quenching.

19. The method of claim 18, wherein a melt extrusion temperature of about 205 to 250° C. is used in said melt-spinning.

20. The method of claim 13, wherein the first winding speed of the winder used for said collecting the quenched filaments is up to 200 m/min and not below 100 m/min.

21. The method of claim 13, wherein the second temperature for said drawing is lower than the third temperature for said annealing.

22. The method of claim 13, wherein the second temperature for said drawing is about 140° C. to 155° C.

23. The method of claim 13, wherein the second winding ratio for said drawing is higher than the third winding ratio for said annealing.

24. The method of claim 13, wherein the second winding ratio for said drawing is up to 6.

25. The method of claim 13, wherein the multiple furnace platform comprises at least three furnaces each having an equal length and spacing to the other furnace.

26. The method of claim 25, wherein each of the at least three furnaces has the length of about 40.5 cm and the spacing of about 6.5 cm between two of the furnaces.

27. The method of claim 13, wherein said drawing is repeated for at least five times before said annealing.

28. The method of claim 13, wherein the third temperature for said annealing is about 160° C. to 170° C.

29. The method of claim 13, wherein the third winding ratio is up to 1.2.

30. The method of claim 13, wherein said annealing is repeated for at least twice before obtaining said plurality of annealed filaments.

31. The method of claim 13, wherein said annealing is performed on the same multiple furnace platform as that for said drawing.

32. The method of claim 13, wherein said plurality of annealed filaments are the polymeric multifilaments with an average diameter of 4 to 10 μm, tensile toughness of at least 100 MJ/m³, tensile strength of greater than 1 GPa, an elongation at break of at least 15%, and a filament count of at least 10 per batch.
